(19) United States
(12) Patent Application Publication
(10) Pub. No.: US 2010/0075588 A1
(43) Pub. Date: Mar. 25, 2010

(54) VENTILATION FAN

(76) Inventor: Ronald W. Haneline, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/545,025

(22) Filed: Aug. 20, 2009

Related U.S. Application Data
(60) Provisional application No. 61/090,578, filed on Aug. 20, 2008.

(51) Int. Cl. B60H 3/00; F04D 29/52; B23P 15/00

(52) U.S. Cl. 454/118; 415/220; 29/888.025

(57) ABSTRACT

Fans and methods of making and using the fans are disclosed. The fans can include a propeller positioned with in a housing, an air straightener, and a housing which is narrower at the outlet than at the propeller.

### CROSS REFERENCE TO RELATED APPLICATIONS

This application claims priority to U.S. Provisional No. 61/090,578, entitled “Ventilation Fan,” filed Aug. 20, 2008, which is hereby incorporated by reference in its entirety.

### BACKGROUND

Fans have numerous applications and utility. Generally, fans have a propeller which draws a fluid, such as air, another gas, or a liquid into a housing, and which directs the fluid out of the housing at an outlet. The propeller may be driven by an electric motor.

### SUMMARY OF CERTAIN ASPECTS OF THE DISCLOSURE

The devices and methods disclosed herein each have several aspects, no single one of which is solely responsible for their desirable attributes. Without limiting the scope of the claims, some prominent features will now be discussed briefly. Numerous other embodiments are also contemplated, including embodiments that have fewer, additional, and/or different components, steps, features, objects, benefits, and advantages. The components, aspects, and steps may also be arranged and ordered differently. After considering this discussion, and particularly after reading the section entitled “Detailed Description,” one will understand how the features of the devices and methods disclosed herein provide advantages over other known devices and methods.

The embodiments can have multiple aspects, no single one of which is solely responsible for their desirable attributes.

Some aspects of the disclosure relate to fan devices. The fans can include, for example, a housing, with an air intake, an air channel, and an air outlet. The fan also can include a propeller, located in the housing nearer the intake than the outlet. The propeller can be configured to cause air or other fluid to flow into the housing from the intake, through the channel, and out of the housing through the outlet. The fan also can include an air straightener, for example located in the housing between the propeller and the outlet. The air straightener can be configured to collimate air flowing therethrough. The air channel can include, for example, first and second cross-sectional areas, each taken perpendicular to the general direction of air flow, where the first cross-sectional area is nearer the intake than the second cross-sectional area, and where the first cross-sectional area is greater than the second cross-sectional area. The fans further can include a motor, for example a motor that can operate at 4.1 amps (115v).

Another aspect of the disclosure relates to methods of manufacturing fans. The methods can include, for example, providing a housing having an air intake, an air channel, and an air outlet, and fixing a propeller inside the housing nearer the intake than the outlet. The propeller can be configured to cause air to flow into the housing from the intake, through the channel, and out of the housing through the outlet. The methods also can include fixing an air straightener inside the housing between the propeller and the outlet. The air straightener can be configured to collimate air flowing therethrough. The air channel can include first and second cross-sectional areas, each taken perpendicular to the general direction of air flow, where the first cross-sectional area is nearer the intake than the second cross-sectional area, and where the first cross-sectional area is greater than the second cross-sectional area. The methods further can include powering the propeller with a motor. For example, the motor can operate at 4.1 amps (115v).

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a side view of one example of an illustrative embodiment of a fan.

FIG. 2 is an end view of the example of an illustrative fan of FIG. 1 looking into the outlet.

FIG. 3 shows an example embodiment of a fan.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Some aspects of the disclosure relate to improved fans and to methods of making and using the fans. The improved fans described herein can provide greater air velocity, for example, in some cases 300-400% greater velocity than non-improved fans. Also, the fans can provide the greater velocity while requiring less energy consumption, thereby saving costs. Thus, the fans described herein provide high performance with little power consumption.

The fans can be used in any setting where increased air velocity is desired.

In some instances, the fans can be used in and/or for trucks and truck trailers, for example, 53 foot trailers, where obtaining airflow deep into a trailer can be a challenge. The fans can be of a size and have an attachment so as to fix the fan to any dock mount in and/or for such a trailer, including standard dock mount installations that are already in place. The energy efficiency of the fans with the air velocity can provide a further advantage for trucks, trailers, ships or any other vessel, especially where fuel and energy usage is important. Some embodiments are mounted in a dock or bay door or opening and can be configured to propel air into the desired area such as for example a semi-truck trailer. Some embodiments can be used with intake louvers in a wall. Some embodiments can be used as a heat and/or smoke exhauster, for example, in a smoke control system. Some embodiments can be as a vertical discharge exhauster, for example, with a power roof ventilator.

Some embodiments have fans which are between about 10 and 100 inches long, preferably about 24 inches and about 72 inches, or any length in between those ranges. Some embodiments can provide air volume, for example, of about 100,000 cfm. Some embodiments may include at least one of a wall housing, a wall collar, a damper, a motor side guard, a weather hood, and a filter, such as a washable filter. Some embodiments may include special coatings. Some embodiments are used in wall louvers and hooded gravity ventilators to provide air intake or relief.

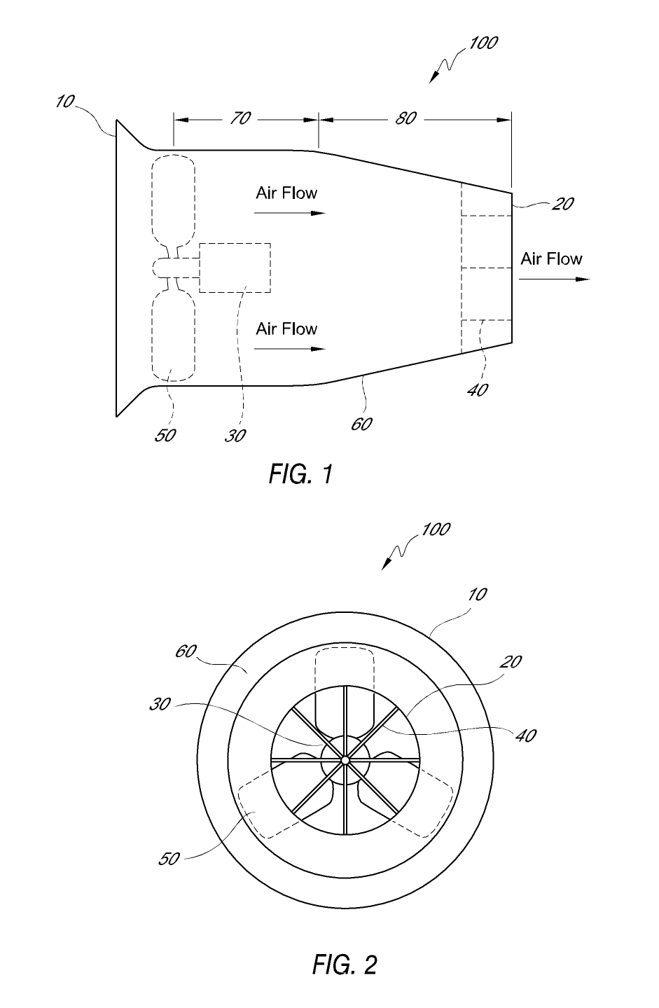

FIG. 1 is a side view of one illustrative embodiment. FIG. 1 shows a fan 100, which has intake 10, outlet 20, propeller 50 connected to motor 30, housing 60, and air straightener 40. The motor 30 of fan 100 can be configured to drive propeller 50, which draws air or another fluid into housing 60 from the intake 10, forcing the air through the housing 60, and out of the housing 60 through the outlet 20. As shown by the air flow indicators, the general direction of the air flow is from left to right in FIG. 1. The general direction of the air flow can be determined at least in part by the orientation of the propeller and the shape of the housing.

The intake 10 of fan 100 is an opening in the end of the housing 60. In this embodiment, intake 10 has a cross-sectional area taken perpendicular to the general direction of the air flow which is larger than the cross-sectional area of the housing 60 in one or more other sections of the housing 60. For example, cross-sectional area of the housing 60 near the propeller 50 taken perpendicular to the general direction of the air flow is smaller than the cross-sectional area of the intake 10 taken perpendicular to the general direction of the air flow. That is one example of the cross-sectional of the intake 10 being greater than the cross-sectional area of another portion of the fan 100. In other aspects the area of the intake 10 may be the same as the cross-sectional area of the region of the fan 50, but the cross-sectional area of the intake 10 may be greater than the cross-sectional area of the outlet 20 for example.

In some embodiments, the intake 10 may include a guard, such as a wire mesh. The guard can be configured to prevent objects larger than a spacing of the guard to enter the housing 60.

In some embodiments, the intake may additionally or alternatively be located around the perimeter of the housing 60. In such embodiments, the housing 60 may have one or more holes formed therein, near the intake end of the housing 60. The holes allow air to flow into the housing 60 on the intake side of the propeller 50. In embodiments with intake holes, the intake end of the housing may be closed. Embodiments with air intake holes in the perimeter of the housing can be beneficial for applications where, for example, the fan 100 is preferably abutted against or near a wall or another surface. In some embodiments, the housing 60 may be formed from as single piece.

The propeller 50 can be located within the housing nearer the intake 10 than the outlet 20. This may allow for the housing 60 to generate a nozzle effect on the air by increasing the portion of the housing 60 which is on the outlet 20 side of the propeller 50. In some aspects, a nozzle effect can be accomplished by designing the housing to be at least partially larger at the intake end and at least partially smaller at the outtake end. Thus, in some aspects the housing or one or more sections of the housing can be tapered or angled at an angle, for example with a slope of about 5% to about 45%, 5% to about 30%, 6% to about 25%, 8% to about 15%, about 10-12%, or any value in between. In some preferred embodiments, the slope or angle can be the angle depicted in FIG. 1.

In some embodiments, the outlet 20 may include a guard, such as a wire mesh. The guard may be configured to prevent objects larger than a spacing of the guard to enter the housing 60.

In the embodiment of FIG. 1, propeller 50 is substantially adjacent to the intake 10, however, other arrangements also can be useful. FIG. 2 shows that propeller 50, of this embodiment, can have three blades. Other embodiments can have different numbers of blades. In addition, the depicted shape of the blades is not intended to be limiting, as various other blade shapes can be used. In some embodiments, multiple propellers 50 can be used, and can be driven by one or more motors.

The housing 60 can include an intake 10, an outlet 20, and an air channel therebetween. In the embodiment shown in FIGS. 1 and 2, the air channel can have multiple sections. A first section 70 has a cross-sectional area corresponding to the diameter of the blade path of the propeller 50. In some embodiments, the first section 70 has a substantially constant diameter for some distance along the path of air flow. For example, 55-99% of the length of section 70 can have the same cross-sectional area, while in other aspects 80%-99% can have the same area or any value in between. As discussed earlier, this cross-sectional area can be less than the cross-sectional area of the intake 10 taken perpendicular to the general direction of the air flow, while in other embodiments it can have the same cross-sectional area, at least in part of its length, to the area of the intake 10. In addition, the cross-sectional area of the first section 70 taken perpendicular to the general direction of the air flow can be greater than the cross-sectional area of the outlet 20 taken perpendicular to the general direction of the air flow. In this embodiment, housing 60 has a second section 80 which has a continuously varying cross-sectional area along the path of the air flow, where the cross-sectional area decreases towards the outlet 20. As shown, the cross-sectional area of the first section 70 taken perpendicular to the general direction of the air flow can be greater than the cross-sectional area of the second section 80 taken perpendicular to the general direction of the air flow. This creates a larger pressure, resulting in an increased air velocity output.

In some embodiments, the housing may include only two tapering sections, for example. In some embodiments, a first tapering section substantially starts at the inlet and substantially ends the second tapering section, which substantially starts at the end of the first tapering section and substantially ends at the outlet, for example.

In the embodiment shown in FIGS. 1 and 2, the cross-sectional shape of housing 60 is substantially circular, however, other shapes may also be used. For example the cross-sectional shape of housing 60 may be non-circular, or may be polygonal, such as square, pentagonal, hexagonal, or octagonal. In some embodiments, the cross-sectional shape of housing 60 may have straight and/or curvilinear portions. In some embodiments, the cross-sectional shape of housing 60 may be irregular.

In the embodiment shown in FIGS. 1 and 2, the cross-sectional area of the second section 80 taken perpendicular to the general direction of the air flow may decrease monotonically and continuously. In other aspects, not depicted, the section 80 may have further sections that are not continuously decreasing, for example, one or more lengths of section that have the same cross-sectional area. In some embodiments, the cross-sectional area of one or more sections of the housing taken perpendicular to the general direction of the air flow may discontinuously change, and may increase along the path of the air flow.

Air straightener 40 can be located within the housing 60 near the outlet 20. FIG. 2 shows that, in this embodiment, air straightener 40 includes 8 radial portions which extend from the center of the housing 60 to contact the housing. Other embodiments can utilize a different numbers of radial portions. For example, some embodiments have 4, 5, 6, 7, 9, or 10 radial portions. The air straightener 40 can extend from the outlet 20 or near the outlet 20 into the housing 60. In this embodiment, the length of the radial portions corresponds to the inner dimension of housing 60 along the portion of the housing 60 into which the air straightener 40 extends. The air straightener 40 can minimize the swirl of the air caused by the spinning propeller 50, or collimates the air from the propeller 50. This can result, for example, in increased air throws and higher air velocity.

In the embodiment of FIGS. 1 and 2, the radial portions are substantially straight, however, in other embodiments, the radial portions can be curved. The curvature of the radial portions may more effectively collimate the air. Such curvature may be along a direction perpendicular to the general direction of air flow and/or along the same direction of air flow.

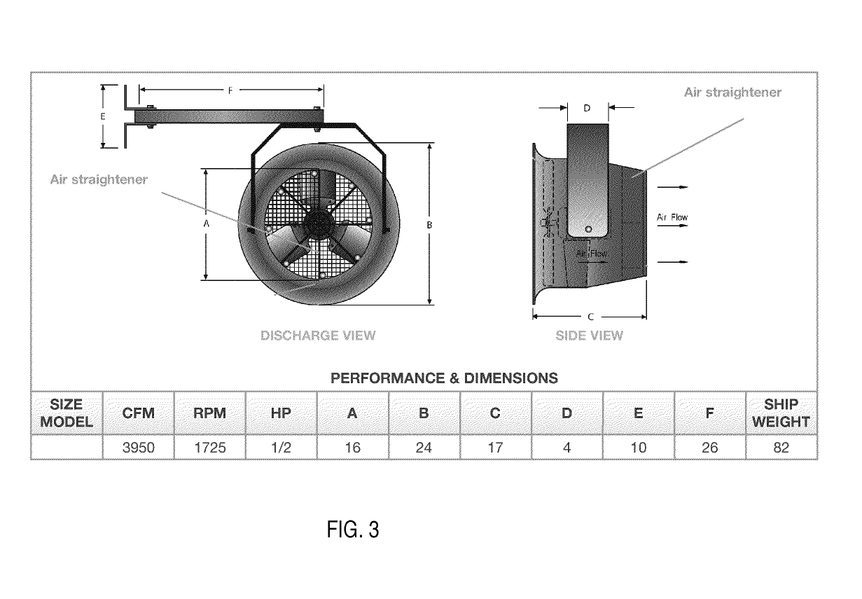

As shown in FIG. 3, a bracket can be attached to the housing such that the fan can be connected to another object, such as a dock (e.g., a loading dock mount), a wall or to a portion of the vehicle or trailer, including into which the fan directs the flow of air. Other attachment elements can also be used. In some embodiments, the attachment element is configured to support and/or house a power supply cord for the fan. FIG. 3 also shows various other characteristics of one embodiment. Non-limiting examples of the relative size of various dimensions are shown in FIG. 3. The actual size of some embodiments may be scaled up based on these or other relative values. The values may, for example, be inches or centimeters. However, the size is not limited to these examples.

As shown in FIG. 3, a guard may be attached to the intake or outlet. For example the guard can be a mesh material attached near or to the outlet opening

The fans can include motors, for example, motors that power the propellers or other parts of the fans. Certain embodiments are particularly power efficient because of the combination of the above mentioned aspects. For example, a fan providing about 4000 CFM of air flow can be operated with about 470 Watts.

The fans described herein can be used in any suitable setting. Some examples include in fixed structures or in a building, for example warehouses, factories, gymnasiums, schools, storage units and the like. The fans can be fixed to loading docks for example. The fans can be used in or for moving vehicles and vessels, such as ships, boats, trucks, trailers, aircraft and the like, for example. Some aspects, therefore relate to vehicles, trailers, containers, ships, vessels and aircraft, etc. that include a fan as described herein. Still some aspect relate to methods of providing airflow to a region, which methods can include providing and/or operating a fan as described herein in the region. The region can be for example, the interior of a vehicle, a trailer, a ship, a vessel, an aircraft, a container, etc. The region can be a part of a structure, such as a building for example. The region can be part of an outdoor area where airflow is desired, for example.

Some embodiments relate to structures that include the fans described herein, for example, structures with the fans attached thereto. For example, some embodiments relate to a loading dock, a warehouse, a factory, a gymnasium, a storage unit, a restaurant, a vehicle (such as for example, a truck, a truck trailer, a boat, a ship, an aircraft), and the like.

Some embodiments relate to methods of manufacturing fans. The methods can include, for example, providing a housing having an air intake, an air channel, and an air outlet, and fixing a propeller inside the housing nearer the intake than the outlet. The propeller can be configured to cause air to flow into the housing from the intake, through the channel, and out of the housing through the outlet. The methods also can include fixing an air straightener inside the housing between the propeller and the outlet. The air straightener can be configured to collimate air flowing therethrough. The air channel can include first and second cross-sectional areas, each taken perpendicular to the general direction of air flow, where the first cross-sectional area is nearer the intake than the second cross-sectional area, and where the first cross-sectional area is greater than the second cross-sectional area. The methods further can include powering the propeller with a motor. For example, the motor can operate at 4.1 amps (115v).

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A fan, comprising:
a housing, comprising an air intake, an air channel, and an air outlet;
a propeller, located in the housing nearer the intake than the outlet, the propeller configured to cause air to flow into the housing from the intake, through the channel, and out of the housing through the outlet;
an air straightener, located in the housing between the propeller and the outlet, the air straightener configured to collimate air flowing therethrough,
wherein the air channel comprises first and second cross-sectional areas, each taken perpendicular to the general direction of air flow, the first cross-sectional area being nearer the intake than the second cross-sectional area, and wherein the first cross-sectional area is greater than the second cross-sectional area.

2. The fan of claim 1, wherein the intake has a cross-sectional area taken perpendicular to the general direction of air flow which is larger than the first cross-sectional area.

3. The fan of claim 1, wherein the first cross-sectional area is greater than the cross-sectional area of the outlet taken perpendicular to the general direction of air flow.

4. The fan of claim 1, wherein at least one cross-sectional shape of the housing is substantially circular.

5. The fan of claim 1, wherein at least one cross-sectional shape of the housing is non-circular.

6. The fan of claim 1, wherein at least one cross-sectional shape of the housing is substantially polygonal.

7. The fan of claim 1, wherein the cross-sectional area of a section of the housing decreases monotonically along the direction of air flow.

8. The fan of claim 1, wherein the air straightener has radial portions which extend from the center of the housing to contact the housing.

9. The fan of claim 7, wherein the radial portions of the air straightener are substantially straight.

10. The fan of claim 7, wherein the radial portions of the air straightener are curved.

11. The fan of claim 1, further comprising a motor configured to drive the propeller.

12. The fan of claim 1, wherein the housing comprises air intake holes.

13. The fan of claim 1, further comprising an attachment configured to fix the fan to a dock mount.

14. A truck trailer loading dock comprising a fan according to claim 1.

15. The truck trailer of claim 14, wherein the trailer has a length of between about 20 and 55 feet.

16. A method of manufacturing a fan, the method comprising:
providing a housing, comprising an air intake, an air channel, and an air outlet;
fixing a propeller inside the housing nearer the intake than the outlet, the propeller configured to cause air to flow into the housing from the intake, through the channel, and out of the housing through the outlet;
fixing an air straightener inside the housing between the propeller and the outlet, the air straightener configured to collimate air flowing therethrough,
wherein the air channel comprises first and second cross-sectional areas, each taken perpendicular to the general direction of air flow, the first cross-sectional area being nearer the intake than the second cross-sectional area, and wherein the first cross-sectional area is greater than the second cross-sectional area.

17. The method of claim 16, wherein the intake has a cross-sectional area taken perpendicular to the general direction of air flow which is larger than the first cross-sectional area.

18. The method of claim 16, wherein the first cross-sectional area is greater than the cross-sectional area of the outlet taken perpendicular to the general direction of air flow.

19. The method of claim 16, wherein at least one cross-sectional shape of the housing is substantially circular.

20. The method of claim 16, wherein at least one cross-sectional shape of the housing is non-circular.

21. The method of claim 16, wherein at least one cross-sectional shape of the housing is substantially polygonal.

22. The method of claim 16, wherein the cross-sectional area of a section of the housing decreases monotonically along the direction of air flow.

23. The method of claim 16, wherein the air straightener has radial portions which extend from the center of the housing to contact the housing.

24. The method of claim 23, wherein the radial portions of the air straightener are substantially straight.

25. The method of claim 23, wherein the radial portions of the air straightener are curved.
